(19) United States
(12) Patent Application Publication
(10) Pub. No.: US 2007/0244684 A1
(43) Pub. Date: Oct. 18, 2007

(54) Method to model 3-D PCB PTH via

(75) Inventors: Rajen Murugan, Round Rock, TX (US); Jimmy D. Pike, Georgetown, TX (US); Abeye Teshome, Austin, TX (US)

Correspondence Address: BAKER BOTTS, LLP, 910 LOUISIANA, HOUSTON, TX, 77002-4995, US

(73) Assignee: Dell Products L.P.

(21) Appl. No.: 11/405,242

(22) Filed: Apr. 17, 2006

(51) Int. Cl. G06F 17/50

(52) U.S. Cl. 703/14

(57) ABSTRACT

A methodology may be used that takes into account the inductive coupling of current transients on the power rails of a printed circuit board (PCB) that may be coupled to the barrel of a via. By taking into account the coupling of the current transients on the power rails of the PCB, more accurate and realistic modeling results may be obtained. Inductive coupling of the current transients from the power rails may be more pronounced at higher frequencies and may be additive for more layer transitions (e.g., more via transitions) of the PCB.

### TECHNICAL FIELD

The present disclosure relates generally to information handling systems, and more particularly, to an improved method for modeling of via parasitics when designing printed circuit boards (PCB) for high speed signal integrity.

### BACKGROUND

As the value and use of information continues to increase, individuals and businesses seek additional ways to process and store information. One option available to users are information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems, e.g., computer, personal computer workstation, portable computer, computer server, print server, network router, network hub, network switch, storage area network disk array, RAID disk system and telecommunications switch.

The information handling system comprises a plurality of subsystems, e.g., processor blades, disk controllers, etc., that may be fabricated on printed circuit boards. These printed circuit boards (PCBs) have signal, power and ground planes that may be on a plurality of levels in the PCBs. The signal, power and/or ground planes may be on different levels and/or be discontinuous. In order to connect together related signal, power and/or ground planes, plated through hole (PTH) vias may be used in the PCBs.

Accurately modeling the parasitics associated with a PCB via is crucial to good signal integrity for high speed signal designs. A present methodology model for three dimensional (3-D) PTH vias may only account for via-to-via coupling and crosstalk. In a paper by Jin Zhao and Jiayuan Fang, “Significance of Electromagnetic Coupling Through Vias in Electronic Packaging,” IEEE 6th Topical Meeting on Electrical Performance of Electronic Packaging, Conference Proceedings, pp. 135-138, August 1997, incorporated herein by reference for all purposes, vias are shown to contribute significant electromagnetic coupling of crosstalk (noise) to signal lines.

However, mutual coupling of current transients (V=Ldi/dt) and/or high speed signals that may exist between the power plane(s) (power rails of the PCB) and/or signal plane(s) edges of these planes, respectively, that are routed close to the barrel of a vias may not be accounted for in the present modeling methodology. At high frequencies and switching speeds, and for multilayer stacked signal and power planes (e.g., a backplane with 12+layers), current transients on the power/signal planes (rails) and/or high speed signals can have a large enough current that inductive coupling (Faraday's law) may affect the accuracy of the computation of parasitics (RLGC—Resistance, Inductance, Conductance, and Capacitance per unit length) of the PTH vias.

### SUMMARY

According to this disclosure, a methodology may be used that takes into account the inductive coupling of current transients on the power rails of a printed circuit board (PCB) that may be coupled to the barrel of a via. By taking into account the coupling of the current transients on the power rails of the PCB, more accurate and realistic modeling results may be obtained. Inductive coupling of the current transients from the power rails may be more pronounced at higher frequencies and may be additive for more layer transitions (e.g., more via transitions) of the PCB.

According to a specific example embodiment as described in the present disclosure, a method of modeling and determining signal insertion loss for a three-dimensional (3-D) printed circuit board (PCB) plated through hole (PTH) via, may comprise the steps of defining a computer simulation of a PCB structure having a plurality of signal, power and ground planes, wherein a PTH via passes through the plurality of signal, power and ground planes; defining in the computer simulation of the PCB structure a signal path from a signal driver source to a signal receiver destination, wherein the signal driver source is coupled to a first microstrip signal conductor, the first stripline signal conductor is connected to the PTH via, the PTH via is connected to a second microstrip signal conductor, and the second stripline signal conductor is coupled to the signal receiver; sweeping a frequency of a signal from the signal driver in the computer simulation; simulating electromagnetically coupled noise from current transients on other ones of the plurality of signal, power and ground planes to the PTH via; and calculating insertion loss between the signal driver and the signal receiver. The first microstrip signal conductor may be on a top plane of the plurality of signal, power and ground planes. The first microstrip signal conductor may have a characteristic impedance of about 50 ohms. The second microstrip signal conductor may be on a bottom plane of the plurality of signal, power and ground planes. The second microstrip signal conductor may have a characteristic impedance of about 50 ohms. The other ones of the plurality of signal, power and ground planes may be between the first and second microstrip signal conductors.

### BRIEF DESCRIPTION OF THE DRAWINGS

A more complete understanding of the present disclosure thereof may be acquired by referring to the following description taken in conjunction with the accompanying drawings wherein:

FIG. 1 is a schematic block diagram of an information handling system;

FIG. 2 is a schematic diagram of a portion of a computer simulation test structure printed circuit board comprising a plurality of layers, a PTH via connecting a top signal layer to a bottom signal layer and also having current transients coupled from aggressor signal crosstalk from other signal/power layers (planes);

FIG. 3 is a schematic diagram plan view of the computer simulation test structure printed circuit board and via of FIG. 2; and

FIG. 4 is a graph of calculated insertion loss as a function of frequency with and without taking into consideration coupled current transients to the via.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU), hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring now to the drawings, the details of specific example embodiments are schematically illustrated. Like elements in the drawings will be represented by like numbers, and similar elements will be represented by like numbers with a different lower case letter suffix.

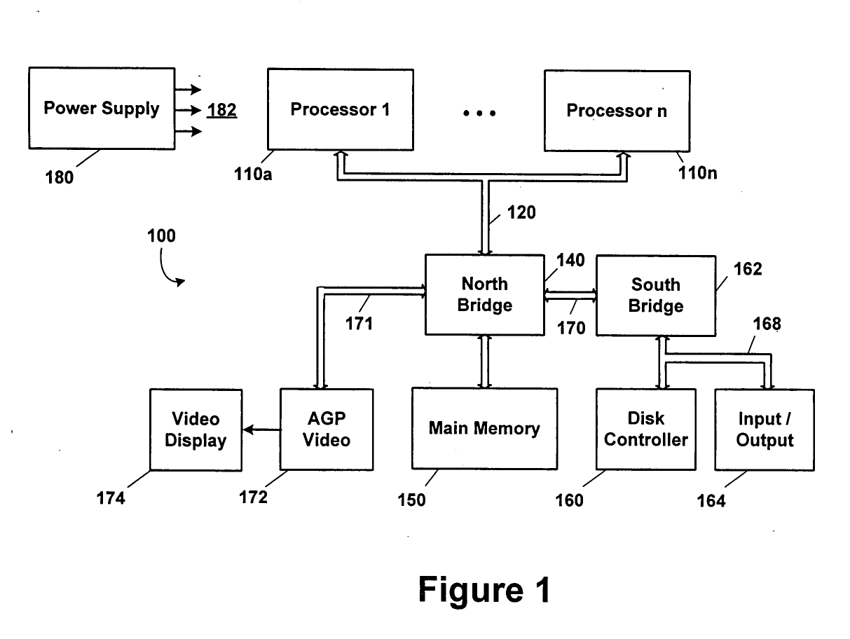

Referring to FIG. 1, depicted is an information handling system having electronic components mounted on at least one printed circuit board (PCB) (motherboard) (not shown) and communicating data and control signals therebetween over signal buses, according to a specific example embodiment of the present disclosure. In one example embodiment, the information handling system is a computer system. The information handling system, generally referenced by the numeral 100, comprises a plurality of physical processors 110, generally represented by processors 110a-110n, coupled to a host bus(es) 120. A north bridge 140, which may also be referred to as a memory controller hub or a memory controller, is coupled to a main system memory 150. The north bridge 140 is coupled to the plurality of processors 110 via the host bus(es) 120. The north bridge 140 is generally considered an application specific chip set that provides connectivity to various buses, and integrates other system functions such as a memory interface. For example, an Intel 820E and/or 815E chip set, available from the Intel Corporation of Santa Clara, Calif., provides at least a portion of the north bridge 140. The chip set may also be packaged as an application specific integrated circuit (ASIC). The north bridge 140 typically includes functionality to couple the main system memory 150 to other devices within the information handling system 100. Thus, memory controller functions such as main memory control functions typically reside in the north bridge 140. In addition, the north bridge 140 provides bus control to handle transfers between the host bus 120 and a second bus(es), e.g., PCI bus 170, AGP bus 171 coupled to a video graphics interface 172 which drives a video display 174. A third bus(es) 168 may also comprise other industry standard buses or proprietary buses, e.g., ISA, SCSI, I²C, SPI, USB buses through a south bridge(s) (bus interface) 162. A disk controller 160 and input/output interface 164 may be coupled to the third bus(es) 168. One or more power supplies 180 may supply direct current (DC) voltage outputs 182 to the aforementioned components (subsystems) of the information handling system 100.

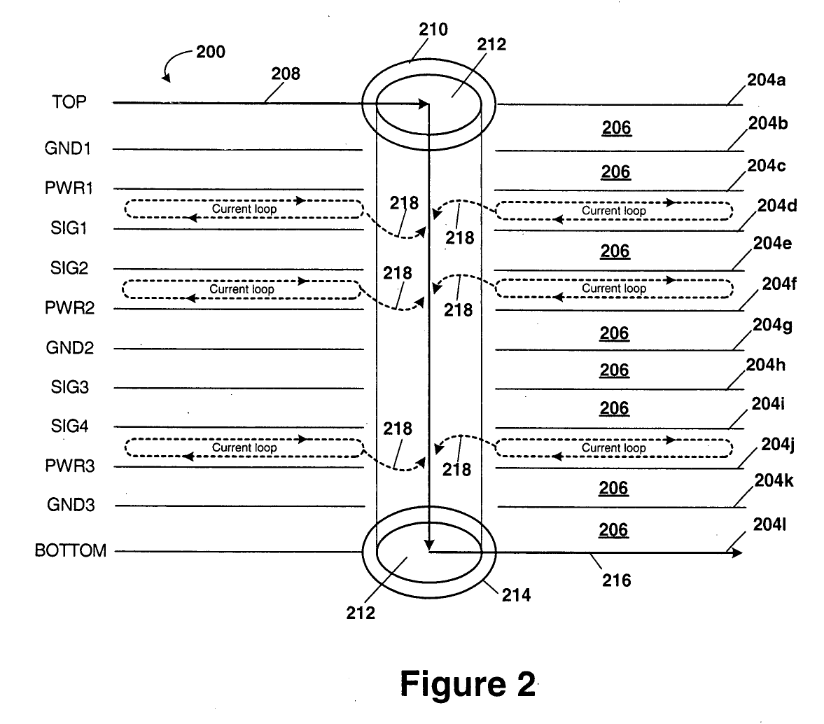

Referring to FIG. 2, depicted is a schematic diagram of a portion of a computer simulation test structure printed circuit board (PCB) comprising a plurality of layers, a PTH via connecting a top signal layer to a bottom signal layer and also having current transients coupled from aggressor signal crosstalk from other signal/power layers (planes). The test structure PCB, generally represented by the numeral 200 comprises a plurality of conductive planes 204 having PCB insulation 206 therebetween. A signal driver (not shown) introduces a test signal to a 6 inch long 50 Ohm impedance microstrip 208 on a top layer of the PCB 200. The microstrip 208 is connected to a top pad 210 that is connected to a PTH via 212. The PTH via 212 is connected to a bottom pad 214 which is connected to another 6 inch long 50 Ohm impedance microstrip 216 on a bottom layer of the PCB 200. The microstrip 216 is connected to a signal receiver (not shown). Current transients 218 from aggressor signals, creating current loops on other signal/power planes 204 (e.g., 204c and 204d, 204e and 204f, and 204i and 204j), are coupled into the barrel of the PTH via 212 by, for example, electromagnetic coupling and/or capacitive coupling. Interference (noise) from these coupled current transients 218 may be more pronounced at higher frequencies and may be additive per layer transition of the PCB.

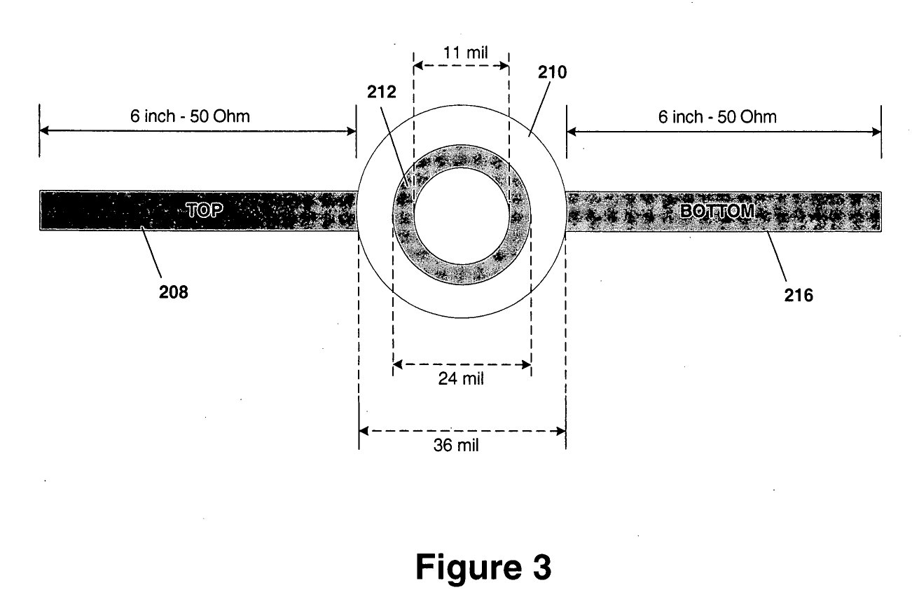

Referring to FIG. 3, depicted is a schematic diagram plan view of the computer simulation test structure printed circuit board and via of FIG. 2. The test structure PCB 200 was defined with microstrips 208 and 216 each having a length of 6 inches and a characteristic impedance of 50 ohms. The top pad 210 was defined with an outer diameter of 36 mils, and the via 212 was defined with an outer diameter of 24 mils.

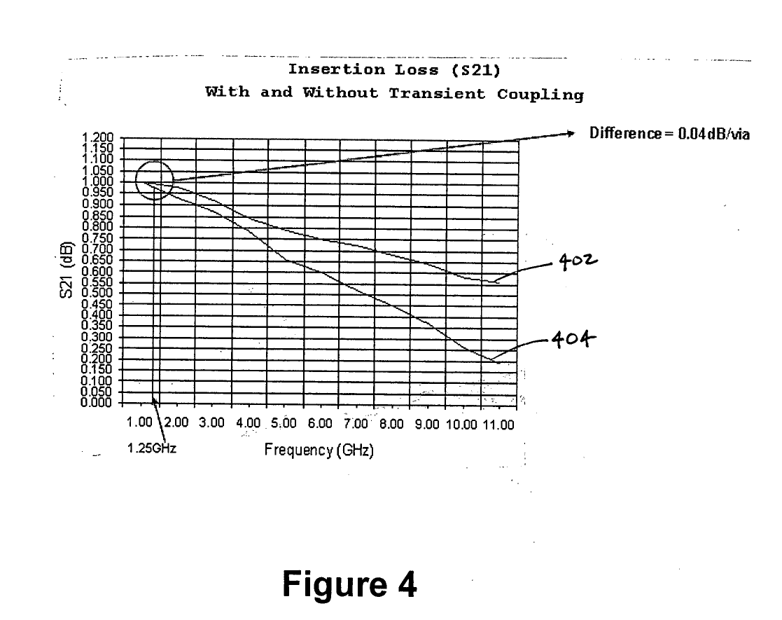

Referring to FIG. 4, depicted is a graph of calculated insertion loss as a function of frequency with and without taking into consideration coupled current transients 218 to the via 212. A computer simulation of a frequency sweep up to 10 GHz was performed on the computer simulated test structure PCB 200 to generate insertion loss (S21) data. The simulated insertion loss (S21) as a function of frequency without considering the coupled current transients 218 is depicted in FIG. 4 as graph line 402. The simulated insertion loss (S21) as a function of frequency, considering the coupled current transients 218, is depicted in FIG. 4 as graph line 404. As can be seen from the graph of FIG. 4, insertion loss (S21) may be underestimated by almost 33 percent when not taking into consideration the coupled current transients 218. This difference in calculated insertion loss (S21) becomes more pronounced as signal frequency is increased and for more layers (e.g., planes 204) transitions (e.g., via 212 transitions).

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A method of modeling and determining signal insertion loss for a three-dimensional (3-D) printed circuit board (PCB) plated through hole (PTH) via, said method comprising the steps of:
defining a computer simulation of a PCB structure having a plurality of signal, power and ground planes, wherein a PTH via passes through the plurality of signal, power and ground planes;
defining in the computer simulation of the PCB structure a signal path from a signal driver source to a signal receiver destination, wherein the signal driver source is coupled to a first microstrip signal conductor, the first stripline signal conductor is connected to the PTH via, the PTH via is connected to a second microstrip signal conductor, and the second stripline signal conductor is coupled to the signal receiver;
sweeping a frequency of a signal from the signal driver in the computer simulation;
simulating electromagnetically coupled noise from current transients on other ones of the plurality of signal, power and ground planes to the PTH via; and
calculating insertion loss between the signal driver and the signal receiver.

2. The method according to claim 1, wherein the first microstrip signal conductor is on a top plane of the plurality of signal, power and ground planes.

3. The method according to claim 2, wherein the first microstrip signal conductor has a characteristic impedance of about 50 ohms.

4. The method according to claim 1, wherein the second microstrip signal conductor is on a bottom plane of the plurality of signal, power and ground planes.

5. The method according to claim 4, wherein the second microstrip signal conductor has a characteristic impedance of about 50 ohms.

6. The method according to claim 1, wherein the other ones of the plurality of signal, power and ground planes are between the first and second microstrip signal conductors.
